(19) United States
(12) Patent Application Publication
(10) Pub. No.: US 2018/0288531 A1
(43) Pub. Date: Oct. 4, 2018

(54) LOUDSPEAKER, METHOD OF MANUFACTURING THE SAME, AND MOVABLE BODY EQUIPPED WITH THE LOUDSPEAKER

(71) Applicant: Panasonic Intellectual Property Management Co., Ltd., Osaka (JP)

(72) Inventors: SHINYA KAGAWA, Osaka (JP); MITSUKAZU KUZE, Osaka (JP)

(21) Appl. No.: 15/915,014

(22) Filed: Mar. 7, 2018

(30) Foreign Application Priority Data
Mar. 30, 2017 (JP) 2017-066495

(51) Int. Cl. H04R 9/06; H04R 9/02; H04R 7/04

(52) U.S. Cl. CPC H04R 9/06; H04R 7/04; H04R 9/025

(57) ABSTRACT

A diaphragm of a loudspeaker is composed of a plate-shaped diaphragm body and a ring-shaped reinforcing part, both of which are bonded to each other. The reinforcing part is provided with a groove that is recessed from a joint surface of the reinforcing part, and the joint surface is joined to the diaphragm body. The groove causes an inner periphery of the reinforcing part to communicate with an outer periphery of the reinforcing part. A connecting wire passes through the groove to electrically couple a voice coil and a terminal disposed to the frame together. The voice coil is attached to the back surface of the diaphragm body.

### BACKGROUND

### 1. Technical Field

The present disclosure relates to a loudspeaker, a method of manufacturing the loudspeaker, and movable bodies equipped with the loudspeaker. The loudspeaker achieves reduction in the thickness and improvement in the productivity.

### 2. Description of the Related Art

Loudspeakers used in audio devices which are mounted in movable bodies such as vehicles have been required to be made thinner because of constraints on their mounting spaces. For reducing their thicknesses, loudspeakers which employ plate-shaped diaphragms have been developed.

### SUMMARY

The present disclosure is intended to provide a loudspeaker which has a structure that features excellent workability in laying connection wires that couple a voice coil and terminals disposed in a frame together.

A loudspeaker according to one aspect of the present disclosure includes:

a frame including a hollow part, a diaphragm disposed in the hollow part of the frame, an edge, a voice coil body, a magnetic circuit, a terminal disposed to the frame, and a connecting wire. The diaphragm is composed of a diaphragm body having a plate shape, and a reinforcing part having a ring shape. The diaphragm body has a first surface being an outer surface, and a second surface opposing the first surface. The reinforcing part is disposed on the second surface of the diaphragm body and along a periphery of the diaphragm body. The edge couples an outer peripheral end of the diaphragm and the frame together. The voice coil body includes: a voice coil, and a cylindrical bobbin having a first end and a second end. The voice coil is wound on the bobbin in the vicinity of the first end of the bobbin. The second end of the bobbin is coupled with the diaphragm body. The voice coil is disposed in a magnetic gap provided in the magnetic circuit. The connecting wire electrically couples the voice coil and the terminal together. The reinforcing part is provided with a groove that is recessed from a joint surface of the reinforcing part. The joint surface is joined to the second surface of the diaphragm body. The groove causes an inner periphery of the reinforcing part to communicate with an outer periphery of the reinforcing part. The connecting wire is laid to pass through the groove.

Moreover, according to another aspect of the present disclosure, a method of manufacturing a loudspeaker includes the steps as follows: First, an outer periphery of a first edge having a ring shape is coupled with a frame such that the first edge is located in a hollow part of the frame. On the other hand, both a reinforcing part having a ring shape and a voice coil body are set in a jig body that has been set in the hollow part of the frame. The reinforcing part configures a part of a diaphragm. The voice coil body includes a voice coil that is wound in the vicinity of a first end of the voice coil body. Then, the voice coil of the voice coil body and a terminal disposed to the frame are electrically coupled together via a connecting wire. The connecting wire is laid to pass through a groove that is opened in a joint surface of the reinforcing part. The groove causes an inner periphery of the reinforcing part to communicate with an outer periphery of the reinforcing part. Moreover, both the reinforcing part and a second end of the voice coil body are bonded to a diaphragm body which configures a part of the diaphragm while the diaphragm body is placed on the joint surface of the reinforcing part so as to cover an opening of the reinforcing part. Then, a second edge is used to couple an outer periphery of the diaphragm body and an outer periphery of the frame together. After that, the jig body is removed from the frame. Then, a magnetic circuit is attached to the frame such that the voice coil of the voice coil body is located in a magnetic gap provided in the magnetic circuit.

Furthermore, a movable body according to another aspect of the present disclosure includes: a body part, a driving unit mounted to the body part, an amplifier mounted in the body part, and a loudspeaker to which an output from the amplifier is fed. Such a loudspeaker has the configuration described above.

In the configuration described above, the diaphragm is configured with the reinforcing part having a ring shape and the diaphragm body having a plate shape which is joined to the reinforcing part. Moreover, the reinforcing part is provided with the groove that is opened in the joint surface. The groove causes the inner periphery of the reinforcing part to communicate with the outer periphery of the reinforcing part. This configuration makes it possible to perform the following steps. That is, before the diaphragm body is joined to the reinforcing part, the connection wire is inserted into the groove. Then, by using the connection wire, the terminal disposed in the frame which has been disposed on the outside of the reinforcing part, is coupled with the voice coil of the voice coil body which has been disposed on the inside of the reinforcing part. This allows the simplification of the manufacturing process, resulting in an improved workability of the process. Therefore, the productivity of a low-profile loudspeaker can be improved.

### BRIEF DESCRIPTION OF THE DRAWINGS

FIG. 1 is a cross-sectional view of a loudspeaker according to an embodiment of the present disclosure;

FIG. 2 is an exploded perspective view of the loudspeaker shown in FIG. 1;

FIG. 3 is a plan view of the loudspeaker shown in FIG. 1, before bonding a diaphragm body;

FIG. 4A is an enlarged cross-sectional view of a principal part of the loudspeaker shown in FIG. 1;

FIG. 4B is an enlarged side view of the principal part of the loudspeaker shown in FIG. 1;

FIG. 4C is an enlarged cross-sectional view of another configuration of the principal part of the loudspeaker shown in FIG. 1;

FIG. 5 is a view illustrating the first half of an assembly process of the loudspeaker shown in FIG. 1;

FIG. 6 is a view illustrating the latter half of the assembly process of the loudspeaker shown in FIG. 1;

FIG. 7A is a plan view of a reinforcing part of the loudspeaker shown in FIG. 1;

FIG. 7B is a plan view of another reinforcing part of a loudspeaker according to the embodiment of the present disclosure;

FIG. 8 is a cross-sectional view of the loudspeaker including the reinforcing part shown in FIG. 7B;

FIG. 9A is a plan view of another diaphragm of a loudspeaker according to the embodiment of the present disclosure;

FIG. 9B is a plan view of a diaphragm body of the diaphragm shown in FIG. 9A;

FIG. 10A is a plan view of still another diaphragm of a loudspeaker according to the embodiment of the present disclosure;

FIG. 10B is a plan view of a diaphragm body of the diaphragm shown in FIG. 10A;

FIG. 11A is a view of the reinforcing part shown in FIG. 7B, when viewed from the direction of arrows 11A-11A in the figure;

FIG. 11B is a side view of another reinforcing part of a loudspeaker according to the embodiment of the present disclosure;

FIG. 11C is a view of the reinforcing part shown in FIG. 7B, when viewed from the direction of arrows 11C-11C in the figure;

FIG. 12 is a conceptual view of a movable body according to the embodiment of the present disclosure;

FIG. 13 is an external perspective view of a loudspeaker of a comparative example;

FIG. 14 is a rear view of the loudspeaker shown in FIG. 13;

FIG. 15A is a cross-sectional view of the loudspeaker shown in FIG. 13;

FIG. 15B is a view illustrating a state in which a connecting wire is led out from a thick-walled part of the diaphragm of the loudspeaker shown in FIG. 13; and

FIG. 16 is a view illustrating an assembly process of the loudspeaker shown in FIG. 13.

### DETAILED DESCRIPTION OF PREFERRED EMBODIMENTS

Prior to descriptions of embodiments of the present disclosure, underlying knowledge forming basis of the present disclosure will be briefly described.

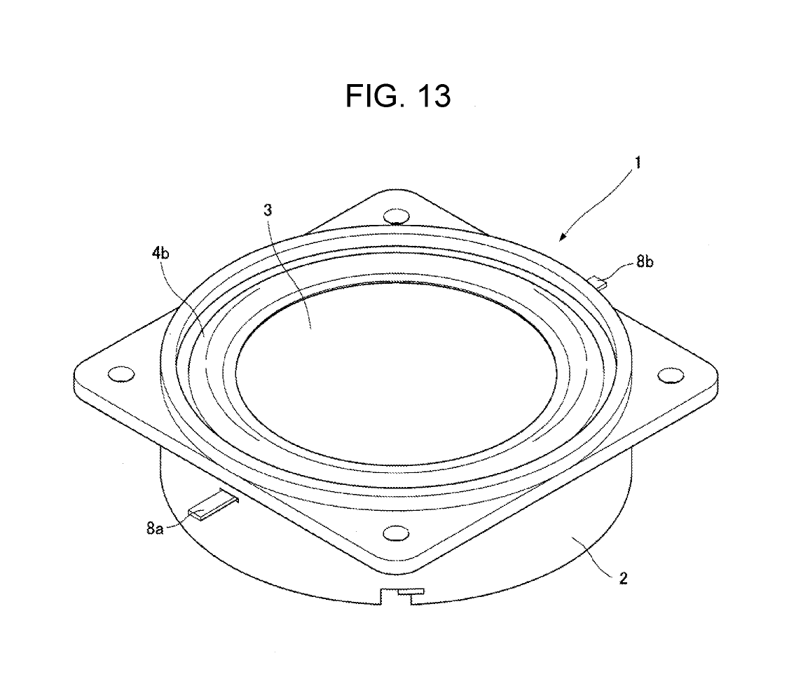

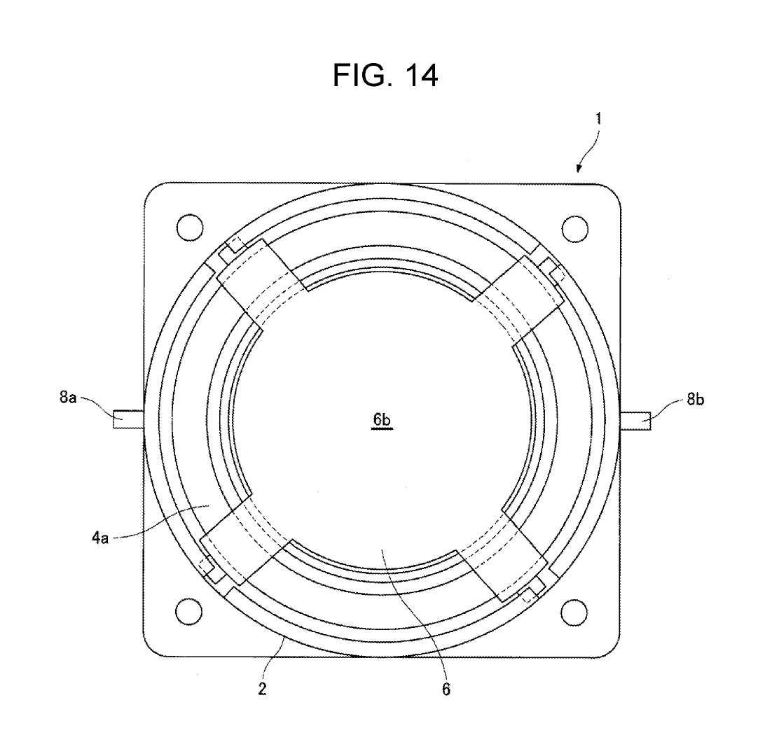

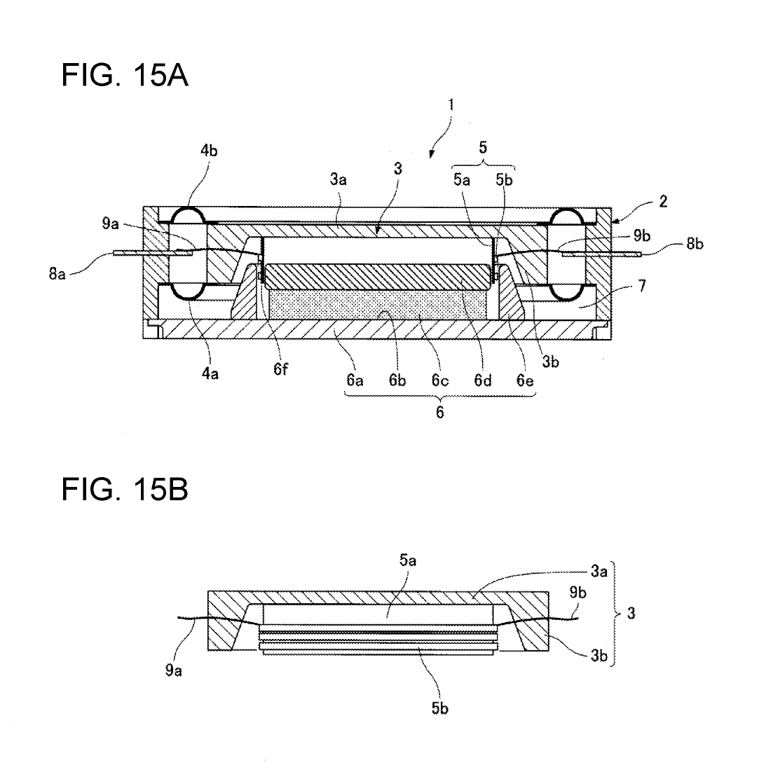

FIGS. 13 and 14 are external views of loudspeaker 1 that employs a plate-shaped diaphragm. FIG. 15A is a cross-elevational view of loudspeaker 1.

Loudspeaker 1 includes frame 2, diaphragm 3, first edge 4a, second edge 4b, voice coil body 5, and magnetic circuit 6.

Diaphragm 3 is disposed in hollow part 7 of frame 2. Diaphragm 3 includes thin-walled part 3a, and thick-walled part 3b that is formed integrally with thin-walled part 3a, at the periphery of thin-walled part 3a. The outer periphery of the upper surface of diaphragm 3 is coupled with a mounting part in the inner periphery of frame 2, via second edge 4b having a ring shape. The outer periphery of the lower surface of diaphragm 3 is coupled with a mounting part in the inner periphery of frame 2, via first edge 4a having a ring shape.

Voice coil body 5 includes bobbin 5a and voice coil 5b, as shown in FIG. 15B. On around a first end of bobbin 5a, voice coil 5b is wound. A second end of bobbin 5a is fixed to the rear surface of thin-walled part 3a of diaphragm 3.

Bottom plate 6a is bonded with the back surface of frame 2, thereby causing magnetic circuit 6 to be engaged with frame 2. Magnet 6c is disposed at an inner part of mounting part 6b of bottom plate 6a, i.e. at a center portion of mounting part 6b. Top plate 6d is disposed on the upper surface of magnet 6c. Yoke 6e is disposed at an outer peripheral part of mounting part 6b. Between the outer periphery of top plate 6d and the inner periphery of the front end of yoke 6e, magnetic gap 6f is formed. Voice coil 5b is disposed in magnetic gap 6f.

Terminals 8a and 8b attached to frame 2 are electrically coupled with voice coil 5b via connecting wires 9a and 9b, respectively. Upon supplying a drive signal to voice coil 5b, a driving force is generated, via bobbin 5a, in the directions of the winding axis of voice coil 5b (i.e. in the up-and-down directions in FIG. 15A), thereby vibrating diaphragm 3.

In loudspeaker 1, connecting wires 9a and 9b penetrate through thick-walled part 3b of plate-shaped diaphragm 3. However, the process of causing connecting wires 9a and 9b to penetrate through thick-walled part 3b poses a problem of low workability.

Hereinafter, embodiments of the present disclosure will be described with reference to the accompanying drawings. Note that, in the following descriptions, directional terms such as “upper” and “lower” are used for convenience, aiming for easy understanding of the drawings, and are not intended to place any limitation on the arrangements of loudspeakers.

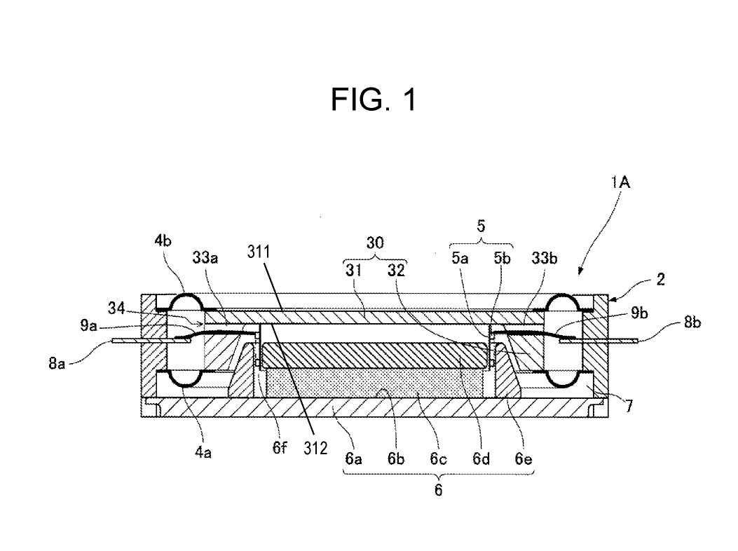

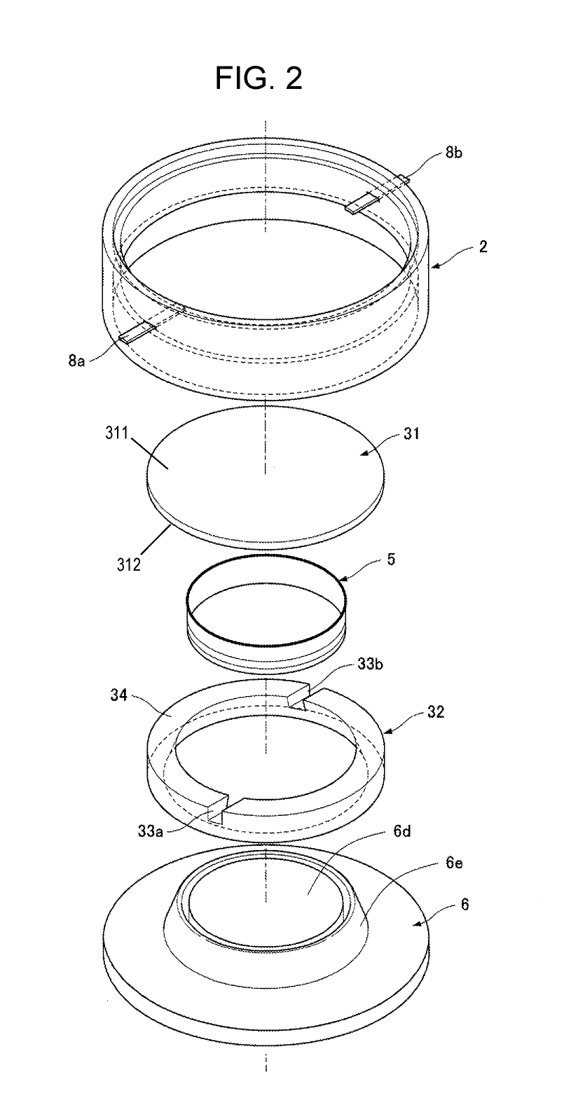

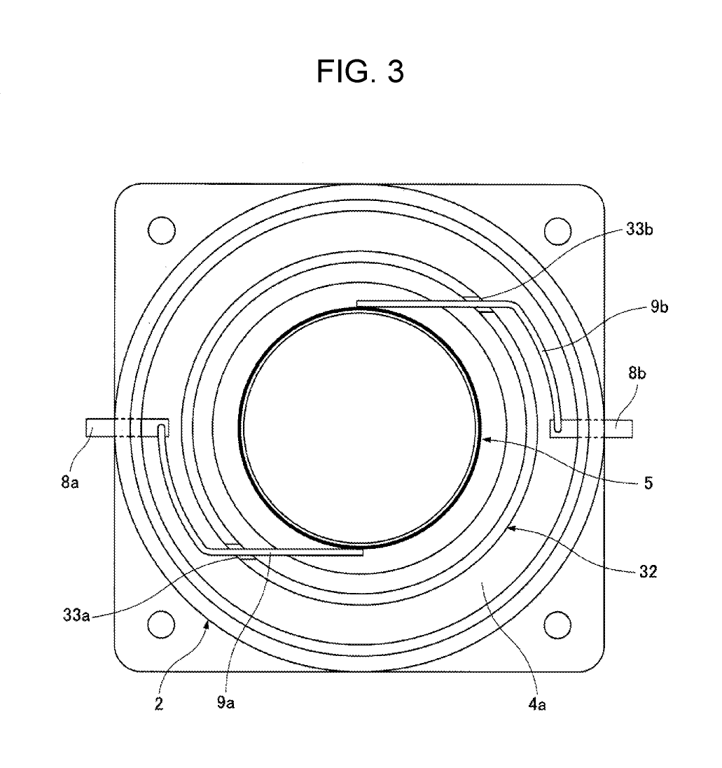

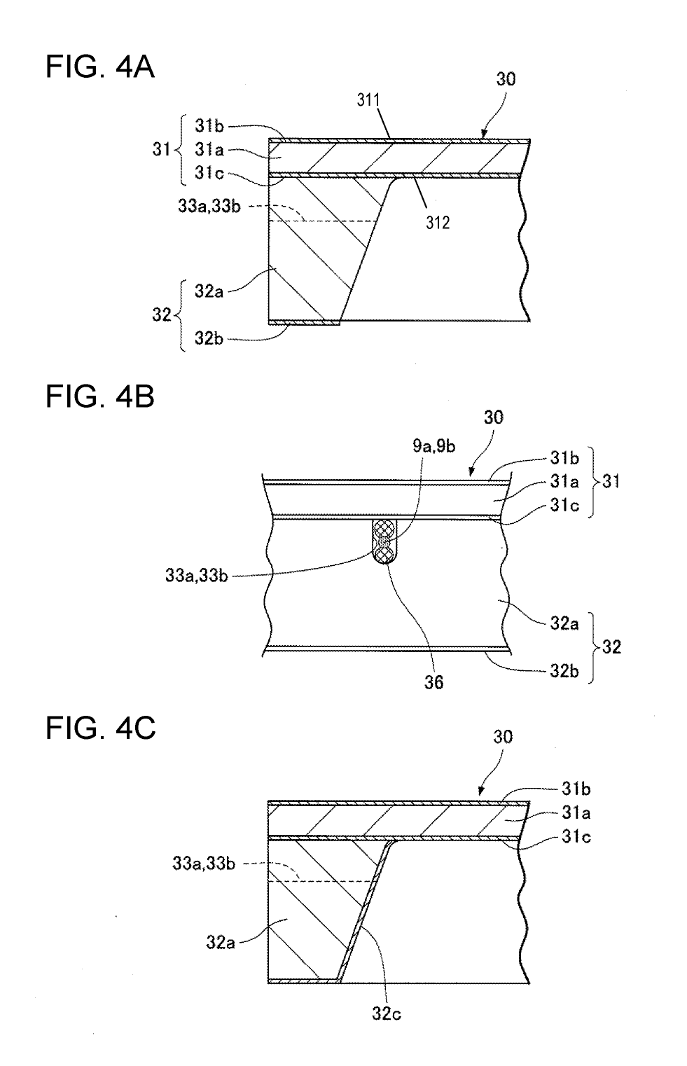

FIG. 1 is a cross-sectional view of loudspeaker 1A. FIG. 2 is an exploded perspective view of loudspeaker 1A. FIG. 3 is a plan view of loudspeaker 1A before diaphragm body 31 is bonded to it. FIG. 4A is an enlarged cross-sectional view of a principal part of loudspeaker 1A. FIG. 4B is an enlarged side view of the principal part of loudspeaker 1A.

Loudspeaker 1A includes frame 2, diaphragm 30, first edge 4a having a ring shape, second edge 4b having a ring shape, voice coil body 5, magnetic circuit 6, and connecting wires 9a and 9b. First edge 4a and second edge 4b support diaphragm 30 from frame 2. Terminals 8a and 8b are attached to frame 2, and are electrically coupled with voice coil 5b via connecting wires 9a and 9b, respectively.

As shown in FIG. 1, frame 2 includes hollow part 7, and diaphragm 30 is disposed in hollow part 7. Diaphragm 30 is composed of diaphragm body 31 having a plate shape and reinforcing part 32 having a ring shape. Diaphragm body 31 includes first surface 311 being an outer surface, and second surface 312 on the reverse side from first surface 311.

As shown in FIGS. 1 and 2, reinforcing part 32 is provided with grooves 33a and 33b that cause the inner periphery of reinforcing part 32 to communicate with the outer periphery of reinforcing part 32. The grooves are recesses in joint surface 34 that is joined to second surface 312 of diaphragm body 31. Connecting wires 9a and 9b pass through grooves 33a and 33b, respectively.

As shown in FIG. 3, in reinforcing part 32, grooves 33a and 33b are formed corresponding to the positions of terminals 8a and 8b disposed in frame 2, respectively. One end of each of grooves 33a and 33b is open at joint surface 34 that is joined to diaphragm body 31. Each of grooves 33a and 33b is formed such that it recesses, from the one end, in the direction away from diaphragm body 31. Connecting wires 9a and 9b pass through grooves 33a and 33b of reinforcing part 32 so as to be electrically coupled with terminals 8a and 8b, respectively.

Note that, as shown in FIG. 3, each of connecting wires 9a and 9b is disposed such that it takes not the shortest route from voice coil body 5, which is disposed at the center portion of loudspeaker 1A, to corresponding one of terminals 8a and 8b. That is, connecting wires 9a and 9b each extend firstly from terminals 8a and 8b along the outer periphery of reinforcing part 32, respectively. Each of grooves 33a and 33b is disposed out of the position that takes the shortest route from voice coil body 5 to corresponding one of terminals 8a and 8b. In the case shown in FIG. 3, each of grooves 33a and 33b is disposed such that corresponding one of connecting wires 9a and 9b can extend along the outer periphery of reinforcing part 32 to reach the position where the groove locates, and then further extend in a straight line so as to be connected to voice coil body 5 at a connecting position. The connecting position is a position shifted by 90 degrees around the axis of voice coil body 5 from the point at the shortest distance from the corresponding one of terminals 8a and 8b, on voice coil body 5. Accordingly, grooves 33a and 33b do not extend in a radial direction of reinforcing part 32.

As described above, each of connecting wires 9a and 9b is routed such that its route includes the path along the outer periphery of reinforcing part 32. Therefore, it is less probable that connecting wires 9a and 9b undergo tension even when voice coil body 5 is driven. For this reason, it is possible to prevent connecting wires 9a and 9b from breaking, and from being detached from voice coil body 5 or terminals 8a and 8b.

First edge 4a couples the outer peripheral end of the lower surface of diaphragm 30 and the mounting part of the inner periphery of frame 2 together. Second edge 4b couples the outer peripheral end of the upper surface of diaphragm 30 and the mounting part of the inner periphery of frame 2 together. That is, first edge 4a couples the outer peripheral end of the surface, which is on the opposite side of reinforcing part 32 from joint surface 34, and the mounting part of the inner periphery of frame 2 together. Second edge 4b couples the outer peripheral end of first surface 311 of diaphragm body 31 and the mounting part of the inner periphery of frame 2 together.

Voice coil body 5 includes cylindrical bobbin 5a and voice coil 5b, as in the case of loudspeaker 1. Diaphragm 30 is composed of diaphragm body 31 having a flat plate shape and reinforcing part 32 having a ring shape. The base end (second end) of bobbin 5a is fixed to second surface 312 of diaphragm body 31. Voice coil 5b is wound on bobbin 5a at a position on the opposite side of bobbin 5a from the base end. That is, voice coil 5b is wound on bobbin 5a in the vicinity of the first end of bobbin 5a.

As in the case of loudspeaker 1, bottom plate 6a is bonded with the back surface of frame 2, thereby causing magnetic circuit 6 to be engaged with frame 2. Magnet 6c is disposed at an inner part of mounting part 6b of bottom plate 6a, i.e. at a center portion of mounting part 6b. Top plate 6d is disposed on the upper surface of magnet 6c. Yoke 6e is disposed at an outer peripheral part of mounting part 6b. Between the outer periphery of top plate 6d and the inner periphery of the front end of yoke 6e, magnetic gap 6f is formed. Voice coil 5b is disposed in magnetic gap 6f.

Diaphragm body 31 may include: core layer (first core layer) 31a formed with a plate-shaped foamed-resin material; and skin layers 31b and 31c disposed on the front and back surfaces, respectively, of core layer 31a. Skin layer 31b configures first surface 311, while skin layer (first skin layer) 31c configures second surface 312.

Like this, reinforcing part 32 may include: core layer (second core layer) 32a formed with a ring-shaped foamed-resin material; and skin layer (second skin layer) 32b disposed only on the bottom surface of core layer 32a. In this case, no skin layer is formed on the inner peripheral surface of core layer 32a.

Skin layers 31b, 31c, and 32b are each preferably formed with a hard and light-weight material. For example, each of skin layers 31b, and 32b is a metal layer made of such as aluminum and titanium, a carbon layer, or the like. Skin layer 31c is preferably formed of a light-weight, high-rigidity, insulating material that is required to achieve electric insulation of connecting wires 9a and 9b. For example, skin layer 31c is formed of an insulating material including: paper, a resin film, a fiber-reinforced plastic, and an insulating film or, alternatively, a metal material provided with any of these insulating materials.

Alternatively, as shown in FIG. 4B, insulating adhesive 36 may be applied inside grooves 33a and 33b. Adhesive 36 secures midway portions of connecting wires 9a and 9b to the insides of grooves 33a and 33b, respectively. In this case, connecting wires 9a and 9b can be fixed such that wires 9a and 9b are not in contact with the surface of skin layer 31c. Accordingly, even in cases where skin layer 31c is formed with an electrically conductive material, it is possible to prevent connecting wires 9a and 9b from developing a short circuit between them via skin layer 31c when assembling the loudspeaker or when driving voice coil 5b. Note that, at least one portion, other than the midway portion, of each of connecting wires 9a and 9b may be secured to the inside of corresponding one of grooves 33a and 33b, with insulating adhesion 36.

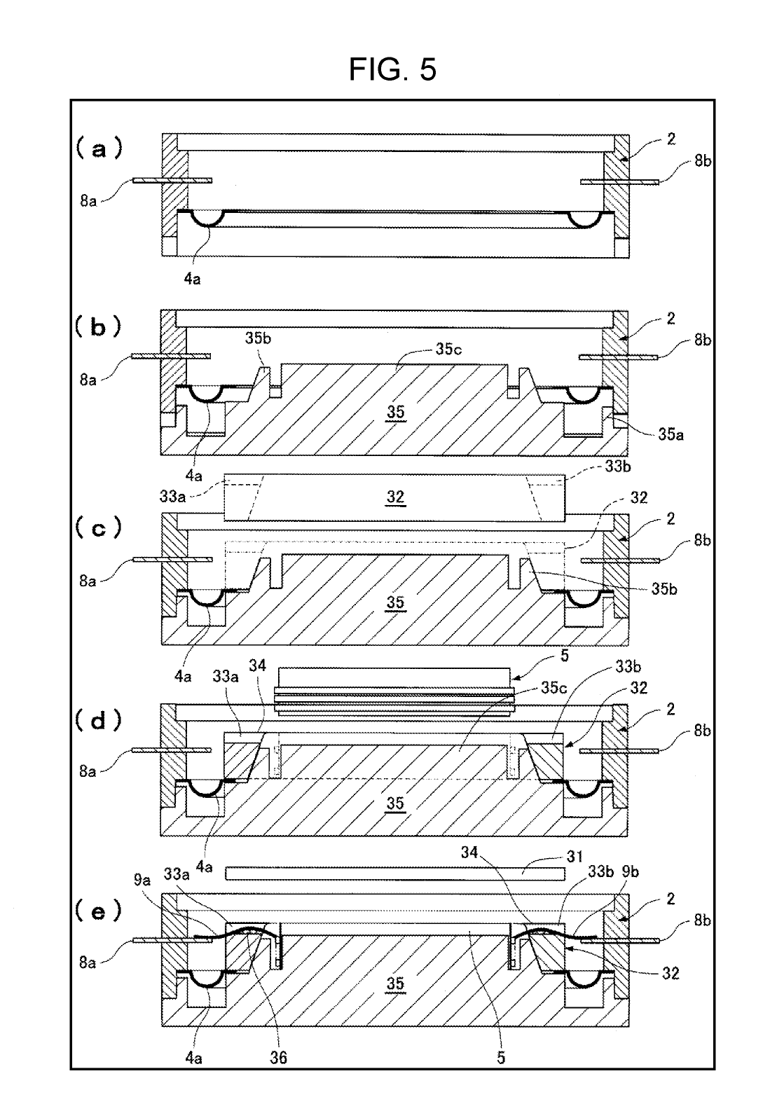

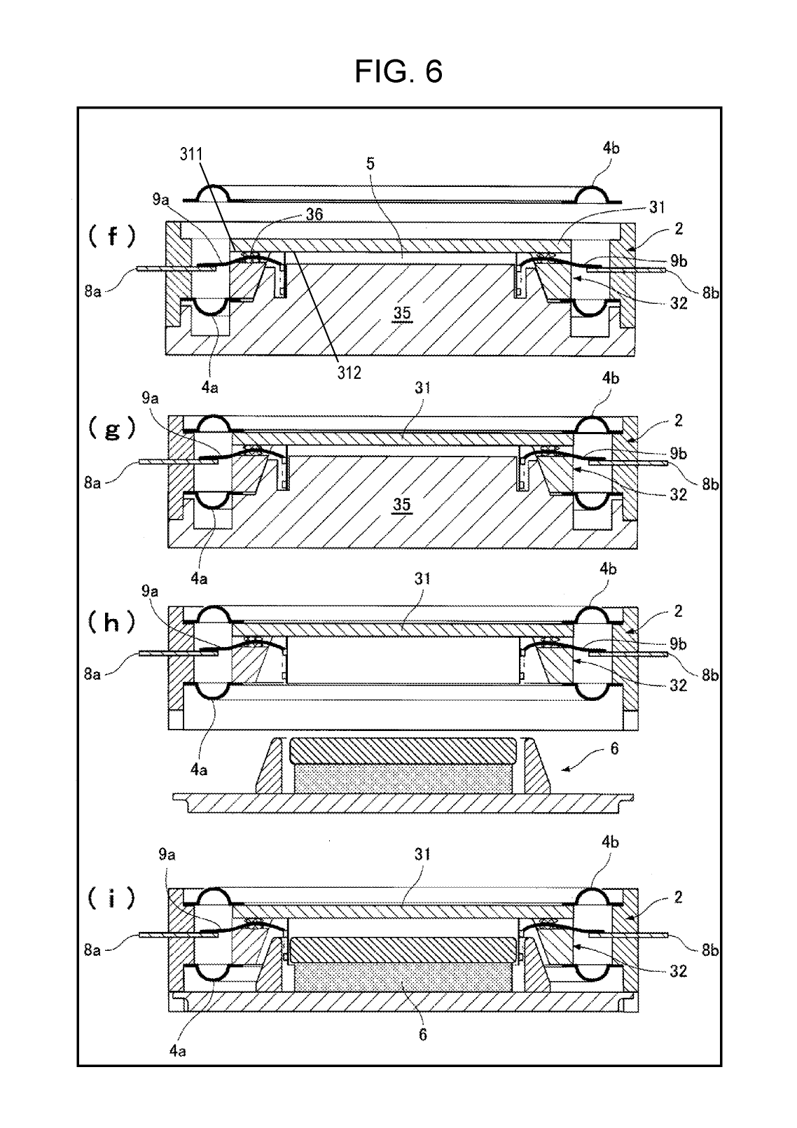

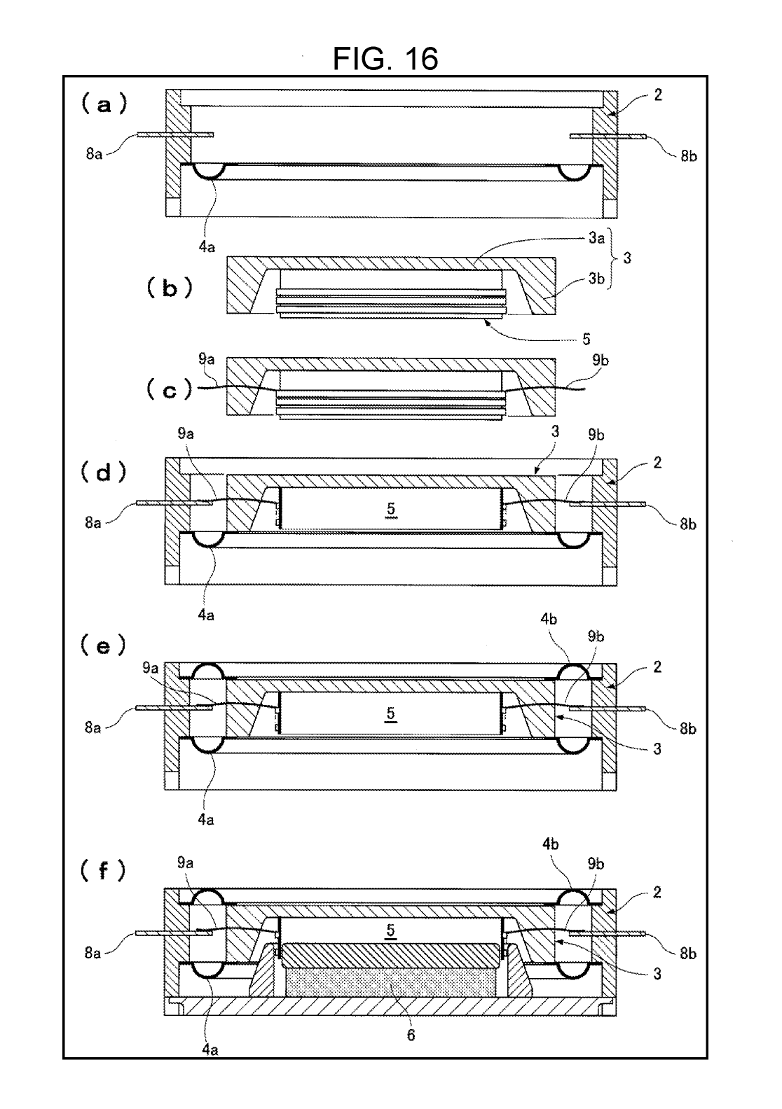

Next, with reference to FIGS. 5 and 6, descriptions will be made regarding an assembly process of loudspeaker 1A, in comparison with that of the loudspeaker in a comparative example shown in FIG. 16.

Assembly Process in Comparative Example

FIG. 16 is a view illustrating a common assembly process of loudspeaker 1 (see FIGS. 13 to 15A) having diaphragm 3 that includes thin-walled part 3a, and thick-walled part 3b integrally formed with thin-walled part 3a.

In step (a) of FIG. 16, an outer peripheral part of first edge 4a is bonded to the inside of frame 2.

In step (b) of FIG. 16, the base end of voice coil body 5 is secured to diaphragm 3 that has been integrally formed. Step (b) is performed separately from step (a) of FIG. 16. Subsequently, in step (c) of FIG. 16, the ends of connecting wires 9a and 9b that have been coupled with voice coil 5b are caused to penetrate through thick-walled part 3b of diaphragm 3, thereby leading out the ends from diaphragm 3 (thick-walled part 3b).

In step (d) of FIG. 16, diaphragm 3 (thick-walled part 3b) which has been prepared in step (c) of FIG. 16, is bonded to an inner part of first edge 4a which has been bonded to frame 2 in step (a) of FIG. 16. Moreover, connecting wires 9a and 9b are electrically coupled with terminals 8a and 8b of frame 2, respectively.

In step (e) of FIG. 16, second edge 4b is bonded to frame 2 and diaphragm 3 therebetween.

In step (f) of FIG. 16, magnetic circuit 6 is attached to frame 2.

As described above, in the manufacture process of the comparative example, for making it possible to bond diaphragm 3 to first edge 4a in step (d) of FIG. 16, performing step (c) of FIG. 16 is necessary in which connecting wires 9a and 9b are drawn out from the inside of diaphragm 3.

Assembly Process According to Embodiment

Next, the assembly process of loudspeaker 1A will be described with reference to FIGS. 5 and 6.

In step (a) of FIG. 5, an outer peripheral part of first edge 4a is bonded to the inside of frame 2.

In step (b) of FIG. 5, frame 2 to which first edge 4a has been bonded in step (a) of FIG. 5 is set onto outer peripheral part 35a of jig body 35.

In step (c) of FIG. 5, reinforcing part 32 is set onto ring-shaped first projection part 35b formed in jig body 35 such that reinforcing part 32 will be positioned in place as indicated by virtual lines. Then, an outer peripheral part of the lower end of reinforcing part 32 is bonded to an inner part of first edge 4a.

In step (d) of FIG. 5, voice coil body 5 is set onto second projection part 35c of jig body 35 such that voice coil body 5 will be positioned in place as indicated by virtual lines. Second projection part 35s is formed at an inner position with respect to first projection part 35b.

In step (e) of FIG. 5, connecting wires 9a and 9b are inserted into grooves 33a and 33b from the openings of grooves 33a and 33b, followed by electrically coupling voice coil 5b with terminals 8a and 8b of frame 2 via connecting wires 9a and 9b, respectively. As described earlier, grooves 33a and 33b are open at joint surface 34 of reinforcing part 32, where the joint surface is to be joined to diaphragm body 31.

Before connecting wires 9a and 9b are respectively inserted into grooves 33a and 33b, insulating adhesive 36 such as a silicone-based adhesive or a rubber-based adhesive, is preferably applied to grooves 33a and 33b. In this case, as adhesive 36 cures, midway portions of connecting wires 9a and 9b are secured such that the midway portions will be not in contact with the surface of skin layer 31c. For this reason, even in cases where skin layer 31c is formed of an electrically conducting material, it is possible to prevent connecting wires 9a and 9b from developing a short circuit between them via skin layer 31c.

In step (f) of FIG. 6, diaphragm body 31 is placed on both voice coil body 5 and reinforcing part 32, both of which are on jig body 35. Then, both joint surface 34 of reinforcing part 32 and the base end of voice coil body 5 are bonded to second surface 312 of diaphragm body 31.

In bonding both reinforcing part 32 and voice coil body 5 to diaphragm body 31, a silicone-based adhesive, rubber-based adhesive, or the like is used. Moreover, for enhancing productivity, an instant adhesive may be used in conjunction with the adhesive described above. Furthermore, a two-part adhesive composed of a base resin and a hardener may be used. In this case, both reinforcing part 32 and voice coil body 5 can be bonded to and coupled with diaphragm body 31, strongly and surely, in a short time. For this reason, the case can achieve an increase in quality, reliability, and productivity as well as good acoustic characteristics.

In step (g) of FIG. 6, an outer peripheral part of second edge 4b is bonded to both frame 2 and first surface 311 of diaphragm body 31.

In step (h) of FIG. 6, jig body 35 is removed from frame 2. In step (i) of FIG. 6, magnetic circuit 6 is attached to frame 2.

In this way, in the manufacture process according to the embodiment, diaphragm 30 is formed by bonding diaphragm body 31 and reinforcing part 32 together. Because reinforcing part 32 is provided with grooves 33a and 33b, connecting wires 9a and 9b can pass through grooves 33a and 33b before bonding diaphragm body 31 with reinforcing part 32, which thereby allows wires 9a and 9b to be laid in grooves 33a and 33b. After that, diaphragm body 31 is bonded to reinforcing part 32, and then second edge 4b is bonded to frame 2 and diaphragm body 31 therebetween. With the aforementioned manufacture process alone, loudspeaker 1A can be assembled.

Therefore, the structure and the assembly process of loudspeaker 1A can eliminate the need for steps (b) and (c) of FIG. 16 which are additional ones different from the assemble steps of bonding the diaphragm to frame 2 via first edge 4a and second edge 4b. Accordingly, good workability compared to the comparative example can be achieved.

Moreover, the manufacture process allows the product to be assembled by handling it only from one direction, which thereby eliminates the need for complicated steps involving turning the product upside down and the like, resulting in an achievement of a speedy and stable manufacturing method.

Furthermore, the manufacture process has a favorable influence greatly on the quality of the product assemble-finished. This results in a reduction in fraction defective, leading to an achievement of manufacture of highly reliable loudspeakers with stable quality.

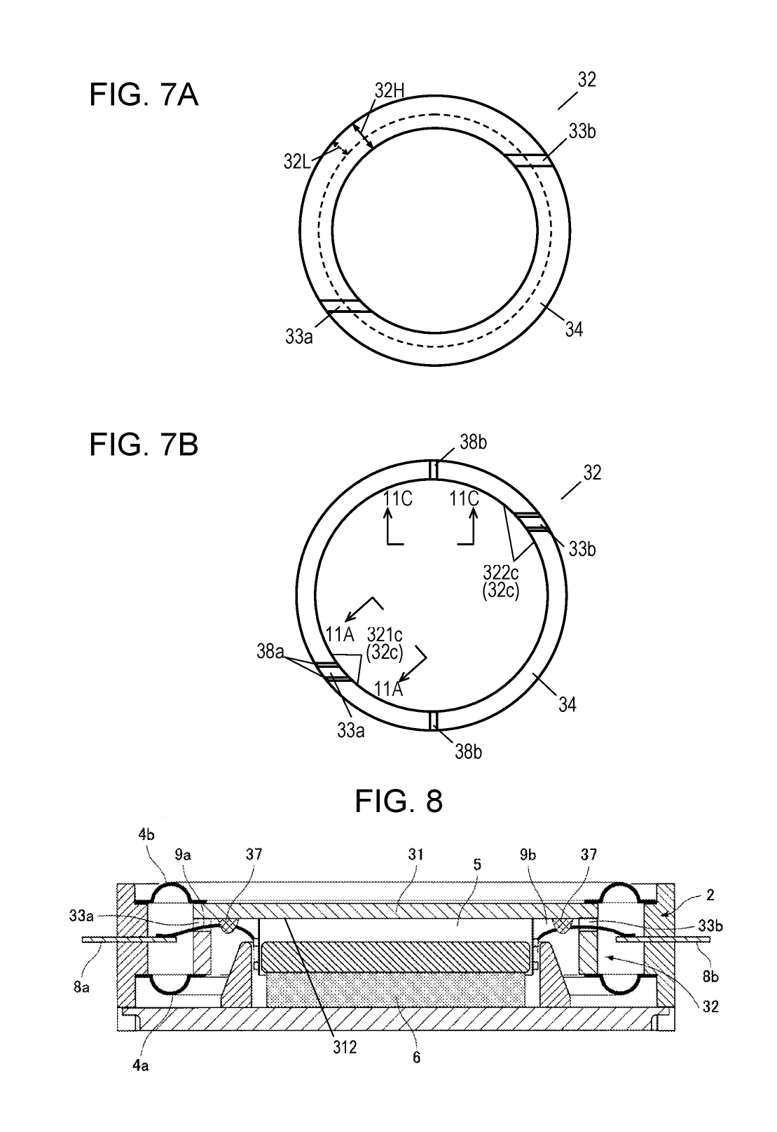

Note that, with the configuration shown in FIG. 1, reinforcing part 32 is such that width 32H of joint surface 34 to be bonded to diaphragm body 31 is larger than width 32L of the surface to be bonded to first edge 4a, as shown in FIG. 7A. However, as shown in FIGS. 7B and 8, width 32H may be equal to width 32L. In this case, midway portions of connecting wires 9a and 9b are preferably secured to second surface 312 of diaphragm body 31 with adhesive 37; each of the midway portions is positioned in wiring between the coupling-position of each of wires 9a and 9b with voice coil body 5 to the reaching-position of each of wires 9a and 9b at reinforcing part 32. This makes it possible to avoid occurring a distortion in the reproducing characteristics, due to contact of connecting wires 9a and 9b with the plane of diaphragm body 31. Moreover, in cases where the surface of skin layer 31c is made of an electrically conducting material, connecting wires 9a and 9b are preferably secured to diaphragm body 31 with adhesive 37 such that midway portions of connecting wires 9a and 9b will not be in contact with the surface of skin layer 31c.

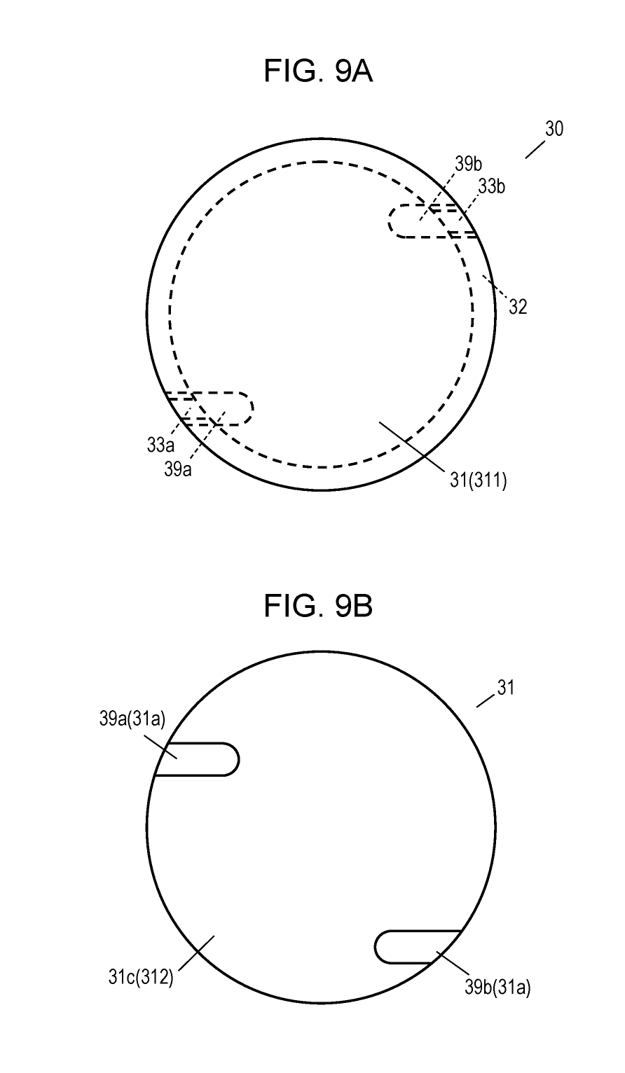

Note that, in cases where connecting wires 9a and 9b are laid in an inappropriate form in step (e) of FIG. 5 and where skin layer 31c is electrically conductive, there is a possibility that connecting wires 9a and 9b come into contact with skin layer 31c to develop a short circuit. Fortunately, adopting the configuration shown in FIGS. 9A to 11C can prevent the occurrence of such a short circuit.

FIG. 9A is a plan view of diaphragm 30, showing first surface 311. FIG. 9B is a plan view of diaphragm body 31, showing second surface 312 on which skin layer 31c is disposed. On second surface 312 of diaphragm body 31, exposed areas 39a and 39b are formed in which skin layer 31c is not formed to expose core layer 31a. Exposed areas 39a and 39b are formed corresponding to the positions of grooves 33a and 33b of reinforcing part 32 such that exposed areas 39a and 39b face grooves 33a and 33b, respectively.

Even in cases where skin layer 31c is electrically conductive, a short circuit between connecting wires 9a and 9b can be avoided by the structure in which core layer 31a exhibits electrically insulating properties and that there exist exposed areas 39a and 39b which are exposed from skin layer 31c and face grooves 33a and 33b, respectively. Note that, exposed areas 39a and 39b may be formed by preventing parts of skin layer 31c from forming through use of a mask or the like, when forming skin layer 31c. Alternatively, exposed areas 39a and 39b may be formed by removing parts of skin layer 31c by etching, peeling, or the like, after skin layer 31c has been formed on the entire lower surface of core layer 31a.

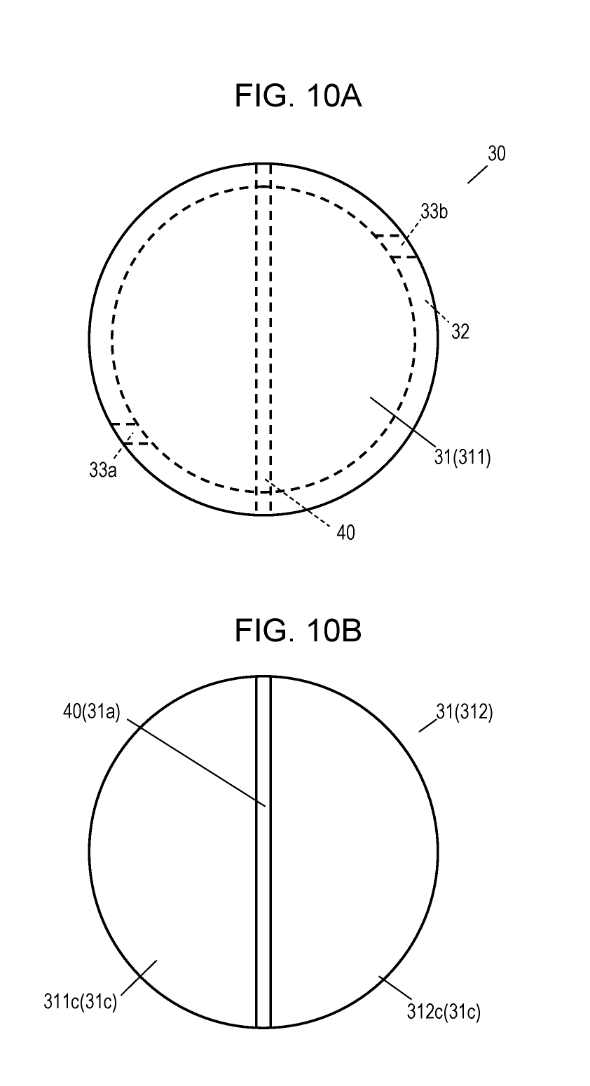

FIG. 10A is a plan view of diaphragm 30, showing first surface 311. FIG. 10B is a plan view of diaphragm body 31, showing second surface 312 on which skin layer 31c is disposed. On second surface 312 of diaphragm body 31, exposed area 40 is formed in which skin layer 31c is not formed to expose core layer 31a. Exposed area 40 is located corresponding to the positions of grooves 33a and 33b of reinforcing part 32.

Even in cases where skin layer 31c is electrically conductive, it is only required for the configuration to be such that core layer 31a exhibits electrically insulating properties, diaphragm body 31 includes exposed area 40 which is exposed from skin layer 31c, and exposed area 40 partitions skin layer 31c into first area 311c facing groove 33a and second area 312c facing groove 33b. With this configuration as well, it is possible to prevent the occurrence of a short circuit between connecting wires 9a and 9b. Note that exposed area 40 can be formed in the same way as for exposed areas 39a and 39b.

Next, modified examples of reinforcing part 32 will be described. In the configuration shown in FIG. 4A, skin layer 32b is formed only on the bottom surface of reinforcing part 32 while no skin layer is formed on the inner peripheral surface of core layer 32a. However, as shown in FIG. 4C, skin layer 32c may be formed on the inner peripheral surface of core layer 32a. Hereinafter, in such a structure, descriptions will be made regarding the configuration of reinforcing part 32 that is aimed at preventing the short circuit between connecting wires 9a and 9b.

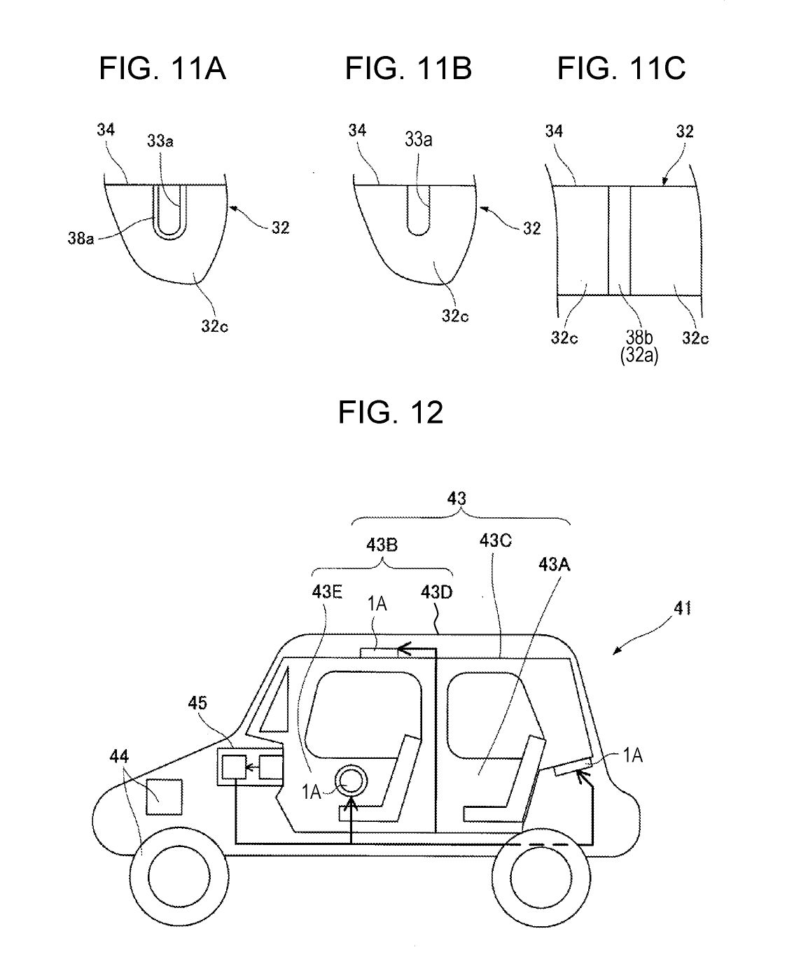

FIG. 11A is a view of reinforcing part 32 shown in FIG. 7B, when viewed from the direction of arrows 11A-11A in FIG. 7B. In the configuration, the peripheral portion of groove 33a is the only area on which skin layer 32c is not formed so as to produce exposed area 38a. In exposed area 38a, core layer 32a is exposed at the peripheral portion of groove 33a. This is also the case for groove 33b. With this configuration, even in cases where skin layer 32c is formed of an electrically conductive material, it is possible to prevent the occurrence of a short circuit between connecting wires 9a and 9b via skin layer 32c. Note that exposed area 38a may be disposed only for one of grooves 33a and 33b. These configurations are applicable to reinforcing part 32 as well shown in FIG. 7A.

Alternatively, exposed area 38b exposing core layer 32a may be disposed between grooves 33a and 33b as shown in FIG. 11C while exposed areas 38a are not disposed at the peripheral portions of grooves 33a and 33b as shown in

FIG. 11B. FIG. 11B is a side view of another configuration of reinforcing part 32, corresponding to the view when viewed from the direction of arrows 11A-11A. FIG. 11C is a view of reinforcing part 32 shown in FIG. 7B, when viewed from the direction of arrows 11C-11C in FIG. 7B. That is, core layer 32a exhibits electrically insulating properties, and includes exposed area 38b exposed from skin layer 32c. Exposed area 38b partitions skin layer 32c into first parts 321c sandwiching groove 33a and second parts 322c sandwiching groove 33b.

With this configuration as well, even in cases where skin layer 32c is formed of an electrically conductive material, it is possible to prevent the occurrence of a short circuit between connecting wires 9a and 9b via skin layer 32c. This configuration is applicable to reinforcing part 32 as well shown in FIG. 7A. Note that, although FIG. 7B shows both exposed area 38a and exposed area 38b, only one of the areas may be disposed.

As described above, FIGS. 9A to 10B show the structure with which a short circuit between connecting wires 9a and 9b via skin layer 31c is prevented by the configuration of diaphragm body 31. On the other hand, FIGS. 7B, 11A, and 11C show the structure with which a short circuit between connecting wires 9a and 9b via skin layer 32c, which is disposed on the inner periphery of core layer 32a, is prevented by the configuration of reinforcing part 32. Combining the former and latter structures can achieve a more reliable prevention of the short circuit between connecting wires 9a and 9b. Meanwhile, in cases where diaphragm body 31 has the configuration shown in FIGS. 9A to 10B, it can achieve a more reliable prevention of the short circuit between connecting wires 9a and 9b when skin layer 32c exhibits electrically insulating properties. Likewise, in cases where reinforcing part 32 has the configuration shown in FIGS. 7B, 11A, and 11C, it can achieve a more reliable prevention of the short circuit when skin layer 31c exhibits electrically insulating properties. Furthermore, securing wires 9a and 9b with adhesive 36 as described with reference to FIG. 4B may be concurrently adopted.

Loudspeaker 1A as described so far can be used as a best suited loudspeaker that is mounted in the space of a movable body such as an automobile.

FIG. 12 is a conceptual view of movable body 41 according to the embodiment. Movable body 41 is equipped with loudspeaker 1A. Note that, in FIG. 12, movable body 41 is exemplified by the automobile; however, movable body 41 is not limited to such an automobile and may be other movable bodies including a boat, aircraft, train, and motorcycle.

Movable body 41 includes body part 43, driving unit 44, amplifier 45, and loudspeaker 1A. Driving unit 44, amplifier 45, and loudspeaker 1A are mounted in body part 43. Driving unit 44 may include at least one of an engine and a motor, tires, and a steering wheel. Output of amplifier 45 is fed to loudspeaker 1A. Note that amplifier 45 may include a part of an audio system for use in the automobile. In this case, amplifier 45 may include a playback system and the like of sound sources. In addition, amplifier 45 may include a part of a car navigation system. In this case, amplifier 45 may include a display device and the like.

Note that body part 43 includes riding space 43A. Loudspeaker 1A is disposed so as to emit sounds into riding space 43A. Body part 43 may further include exterior part 43B and interior part 43C. Exterior part 43B isolates riding space 43A from the outside. Exterior part 43B includes roof 43D, doors 43E, and the like. Interior part 43C is disposed between exterior part 43B and riding space 43A. Loudspeaker 1A is accommodated between interior part 43C and exterior part 43B. Note that the mounting location of loudspeaker 1A is not limited to that described above, and may be other places including: a dashboard, and a rear tray (not shown). Note that, although FIG. 12 shows the case where three units of loudspeakers 1A are mounted, the number of the loudspeakers is not particularly limited, and may be one or not smaller than four, for example.

As described above, the technology according to the present disclosure contributes to the improvement in performance of low-profile loudspeakers and various devices using them, and to the simplification of methods of manufacturing them.

What is claimed is:

1. A loudspeaker comprising:
a frame including a hollow part;
a diaphragm disposed in the hollow part of the frame, the diaphragm including:
a plate-shaped diaphragm body having:
a first surface being an outer surface; and
a second surface opposing the first surface; and
a ring-shaped reinforcing part disposed on the second surface of the diaphragm body and along a periphery of the diaphragm body;
an edge coupling an outer peripheral end of the diaphragm and the frame together;
a voice coil body including:
a cylindrical bobbin having:
a first end; and
a second end coupled with the diaphragm body; and
a voice coil wound on the bobbin in a vicinity of the first end of the bobbin;
a magnetic circuit provided with a magnetic gap in which the voice coil is disposed;
a first terminal disposed to the frame; and
a first connecting wire electrically coupling the voice coil and the first terminal together,
wherein the reinforcing part has a joint surface in contact with the second surface of the diaphragm body;
the reinforcing part is provided with a first groove recessed from the joint surface, the first groove causing an inner periphery of the reinforcing part to communicate with an outer periphery of the reinforcing part; and
the first connecting wire passes through the first groove of the reinforcing part.

2. The loudspeaker according to claim 1, wherein the diaphragm body includes:
a first core layer formed with a plate-shaped foamed-resin material; and
a first skin layer disposed on a surface of the first core layer, the first skin layer configuring the second surface.

3. The loudspeaker according to claim 2, wherein the first skin layer is an electrical insulator.

4. The loudspeaker according to claim 2,
wherein the first skin layer is electrically conductive; and
an electrically insulating adhesive is disposed between the first skin layer and the first connecting wire.

5. The loudspeaker according to claim 2,
wherein the first skin layer is electrically conductive; and
the first core layer is an electrical insulator and includes an exposed area exposed from the first skin layer, the exposed area facing the first groove.

6. The loudspeaker according to claim 2, further comprising:
a second terminal disposed to the frame; and
a second connecting wire electrically coupling the voice coil and the second terminal together,
wherein the reinforcing part is further provided with a second groove through which the second connecting wire passes;
the first skin layer is electrically conductive;
the first core layer is an electrical insulator and includes an exposed area exposed from the first skin layer; and
the exposed area partitions the first skin layer into a first area facing the first groove and a second area facing the second groove.

7. The loudspeaker according to claim 1, wherein the reinforcing part includes:
a second core layer formed with a ring-shaped foamed-resin material; and
a second skin layer disposed on an end surface opposing the joint surface.

8. The loudspeaker according to claim 1, wherein the reinforcing part includes:
a second core layer formed with a ring-shaped foamed-resin material; and
a second skin layer disposed on an inner peripheral surface of the second core layer.

9. The loudspeaker according to claim 8,
wherein the second skin layer is electrically conductive; and
the second core layer is an electrical insulator, and includes an exposed area exposed from the second skin layer to a peripheral portion of the first groove.

10. The loudspeaker according to claim 8, further comprising:
a second terminal disposed to the frame; and
a second connecting wire electrically coupling the voice coil and the second terminal together,
wherein the reinforcing part is further provided with a second groove through which the second connecting wire passes;
the second skin layer is electrically conductive;
the second core layer is an electrical insulator and includes an exposed area exposed from the second skin layer; and
the exposed area partitions the second skin layer into first parts sandwiching the first groove and second parts sandwiching the second groove.

11. The loudspeaker according to claim 1, wherein at least a part of the first connecting wire is fixed in the first groove of the reinforcing part of the diaphragm.

12. The loudspeaker according to claim 1,
wherein the reinforcing part has an opposite surface opposing the joint surface; and
the edge includes:
a first edge coupling an outer peripheral end of the opposite surface of the reinforcing part and an inner peripheral part of the frame together, and
a second edge coupling an outer peripheral end of the first surface of the diaphragm body and the inner peripheral part of the frame together.

13. A method of manufacturing a loudspeaker, the method comprising:
coupling an outer periphery of a ring-shaped first edge and a frame together, the first edge being located in a hollow part of the frame;
setting, in a jig body, both a ring-shaped reinforcing part and a voice coil body, the jig body being set in the hollow part of the frame, the reinforcing part having an opening and configuring a part of a diaphragm, the voice coil body including a voice coil wound in a vicinity of a first end of the voice coil body;
electrically coupling the voice coil of the voice coil body to a terminal disposed in the frame, by using a connecting wire passing through a groove of the reinforcing part having a joint surface, the groove being opened in the joint surface, the groove causing an inner periphery of the reinforcing part to communicate with an outer periphery of the reinforcing part;
bonding both the reinforcing part and a second end of the voice coil body to a plate-shaped diaphragm body, while the diaphragm body is placed on the joint surface of the reinforcing part so as to cover the opening of the reinforcing part, the diaphragm body configuring a part of the diaphragm;
coupling an outer periphery of the diaphragm body and an outer periphery of the frame together, by using a second edge;
removing the jig body from the frame; and
attaching a magnetic circuit to the frame such that the voice coil of the voice coil body is located in a magnetic gap disposed in the magnetic circuit.

14. A movable body, comprising:
a body part;
a driving unit mounted to the body part;
an amplifier mounted in the body part; and
a loudspeaker according to claim 1, being fed with an output from the amplifier.
